(19) United States
(12) Patent Application Publication
(10) Pub. No.: US 2022/0325820 A1
(43) Pub. Date: Oct. 13, 2022

(54) Coolant Valve with Integrated Sensors

(71) Applicant: Shubhada Surve, Itasca, IL (US)

(72) Inventor: Shubhada Surve, Itasca, IL (US)

(21) Appl. No.: 17/715,394

(22) Filed: Apr. 7, 2022

Related U.S. Application Data
(60) Provisional application No. 63/171,781, filed on Apr. 7, 2021.

(51) Int. Cl. F16K 37/00; F16K 31/02

(52) U.S. Cl. CPC F16K 37/005; F16K 31/02

(57) ABSTRACT

A valve has inlet and outlet port members with at least some having integrated sensor ports with sensors pre-provided in fluid tight connection to the sensor ports permitting a more compact construction than prior art systems.

### CLAIM OF PRIORITY

This application claims the benefit of U.S. Provisional Application No. 63/171,781 filed Apr. 7, 2021, which is incorporated herein by reference in its entirety.

### FIELD OF THE INVENTION

The present invention relates to a coolant valve having integrated sensor ports disposed along inlet and/or outlet ports of the valve with integrated sensors therein.

### BACKGROUND OF THE INVENTION

Different types of sensors, such as pressure sensors, temperature sensors, pressuring and temperature sensors are used to monitor pressure and/or temperatures of coolant systems. Existing coolant valve designs do not have such sensors. Instead, sensors are mounted along the coolant lines as separate components. When adding the valves, a connection is required at the valve in the stream or flow of the valves. A possibility exists of unwanted leaking at the joints, operators failing to install the correct sensors at specified locations, or other issues.

What is needed is a valve configurable or even pre-equipped with specific sensors thereby simplifying the assembly process to the customer.

### SUMMARY OF THE INVENTION

It is an object of many embodiments of the present invention to provide an improved valve configuration having integrated port locations along inlets and/or outlets of the valve.

It is another object of many embodiments of the present invention to provide an improved valve construction with integrated sensors.

Accordingly, in accordance with the presently preferred embodiment of the present invention, an improved valve such as a coolant valve is provided preferably having integrated sensor ports along at least some of the inlet/outlet ports, possibly with sensors for use in monitoring the performance of the system where the valve is to be employed. Specifically, a valve may have a single inlet and dual outlet choice construction such as shown in FIG. 1. Alternatively, a valve may have dual inlet choices directing to a single outlet or other constructions as known in the art.

Ports may be provided with either threaded, molded or other connectors and provide either a metal sensor connection to a plastic port assembly possibly using metal inserts, direct threading or other connection system.

The valves preferably provide either or both of selected inlet and outlet ports with an integrated sensor port preferably extending perpendicularly to the direction of flow for many embodiments. This sensor port preferably receives a specific sensor inserted therein and seals in a fluid tight engagement with the port. The sensor port is located internally disposed towards the stemshell from the applicable inlet/outlet port.

Accordingly, a much more compact construction can be provided to the marketplace as has previously been provided. Also, by pre-providing sensors with the valve, the technicians assembling the system have less opportunity to make mistakes.

### BRIEF DESCRIPTION OF THE DRAWINGS

The particular features and advantages of the inventions with other objects will become apparent from the following description taken in connection with the accompanying drawings in which:

FIG. 1 is a top perspective view of the preferred embodiment of the present invention; and

FIG. 2 is a bottom perspective view of an alternative preferred embodiment of the present invention.

### DETAILED DESCRIPTION OF THE PREFERRED EMBODIMENT

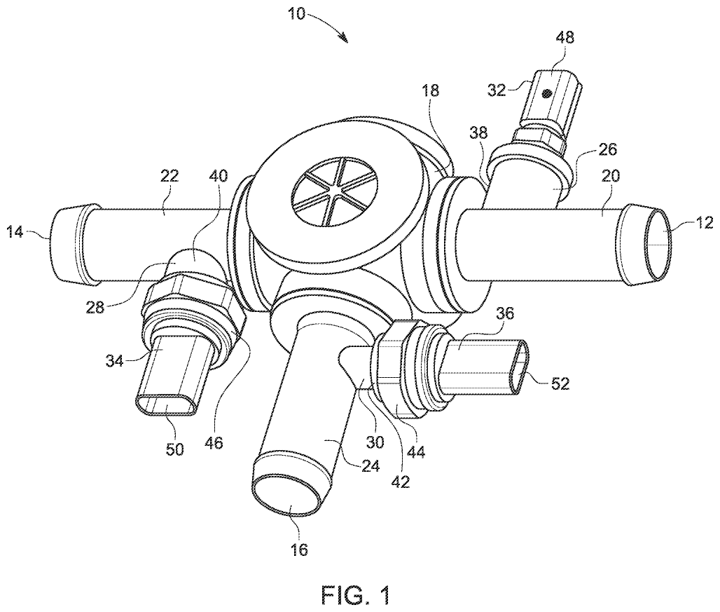

FIG. 1 shows a valve 10 construction of a presently preferred embodiment of the present invention. FIG. 1 has a plurality of input and/or output ports, namely ports 12,14,16. At least one of the ports 12,14,16 is at least selectively an inlet port and at least one of the ports 12,14,16 is at least selectively an outlet port. For this embodiment, it is envisioned that there are either two inlet ports selected from the group of 12,14,16 or two outlet ports selected from the group of inlet/outlet ports 12,14,16. Other valves 10 may have different numbers and/or arrangements of inlet/outlet ports 12,14,16.

Valve body 18 preferably has a stemshell or other controller internal thereto to direct the flow as desired by an operator, in accordance with a program, etc. At least one if not all of the port members 20,22,24 extending from a stemshell housing or valve body 18 having the ports 12,14,16 at ends of the port members 20-24 respectively with sensor port bodies 26,28,30 disposed intermediate the inlet/outlet ports 12,14,16 and the valve body 18. The sensor ports 26,28,30 can be of various constructions but are preferably perpendicularly oriented to the direction of flow from the various inlet and outlet ports 12,14,16.

This type construction permits a sensor such as sensors 32,34,36 to be directed into the sensor port bodies 26,28,30 and then secured to the sensor port bodies 38,40,42 such as with cooperating threads as would be understood by those of ordinary skill in the art based on the construction of the nuts 44,46 which have internally directed threads which may cooperate with extending directed threads of the sensor ports. Other connection systems or otherwise connecting a sensor 30 internal to sensor port bodies 38 may be provided with at least some embodiments. Water tight connections are preferable for many embodiments.

While providing the sensor port bodies 26,28,30 along and/or integral to the various inlet and outlet port bodies 40,42,44, more compact constructions can then be provided than prior art designs where the sensors were connected after the end of the ports 12,14,16 along other portions of the system, such as a cooling system. This construction allows the sensor port bodies 26,28,30 to be integral to inlet/outlet the port members 20,22,24 such as molded with or formed without later connection such as joining, welding, etc. This construction also permits sensors 32-36 to be connected to the port bodies 26-30 before sending to a customer (normally a manufacturer) for at least some embodiments. Sensors 32-36 may have connectors 48,50,52 to connect to various communication/electrical systems such as 2-pin, 3-pin, 4-pin or other connections. By pre-connecting sensor 32-36, there is less opportunity for mistakes later in the assembly process, such as installing the wrong sensor, installing the correct sensor at the wrong location, or having leaks in the system, etc.

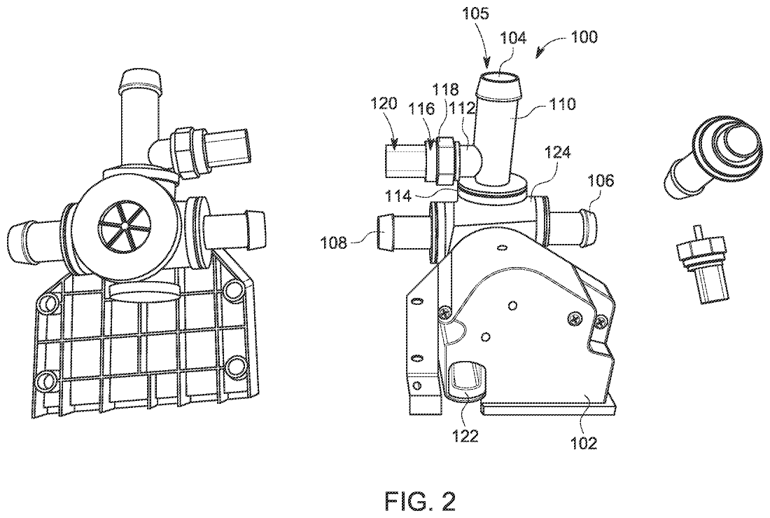

FIG. 2 shows an alternatively preferred embodiment of a valve 100 having an actuator 102 configured to change the position of the valve 100 to provide the various flows from inlet and outlet ports 104,106,108 with at least one of the ports 104,106,108 being an inlet port and at least one of the ports 104,106,108, being an outlet port. The other of the ports 104,106,108 being either an inlet or an outlet port in this construction. Obviously if there are more ports then there could be more than two inlet or outlet ports 104,106,108. Actuator 102 can be utilized to provide a desired flow path among the various ports 104,106,108.

Port 104 is at an end 105 of port body 110 having a sensor port 112 integrally extending along a portion thereof with the sensor port body 114 being oriented perpendicular to the flow port 104. Thus, a sensor 116 can be inserted into the sensor port 112 and secured thereto such as with the nut 118 connecting to external (or possibly internal) threads on the sensor port body 114 to provide a watertight connection and the pin connector 120 utilized to plug the sensor 116 into pins for connectivity. Other sensors 116 may connect to sensor port 112 and/or communication systems differently.

Standard automotive or other connectors (2-pin, 3-pin, 4-pin, etc.) or others could be used at the pin connection 120. With such a construction as shown in FIG. 2 as provided to a customer, the customer may only need to install the ports 104,106,108 to the desired conduits, plug in the sensor connector 120 of the sensor 116 and connect to the actuator 102 at connection 122 without having to separately connect sensors to the system, such as along a cooling system. This provides an efficient way of providing sensor(s) 116 to an appropriate electrical connection and sensor output to a processor possibly used in control or monitoring through connector 122 for sensed characteristics of the flow path through the valve 100 at the sensor 116.

Accordingly, unlike prior art designs, the sensor ports 112 are located intermediate the ports 104,106,108 and the valve body 124 for many embodiments thus making the design more compact than has been done in prior art designs and more efficient in terms of constructions by being able to pre-provide the desired sensor 116 whether it be a temperature, pressure or pressure/temperature sensor and/or other sensor connected or preconnected to the valve 100 at the sensor port(s) 112 possibly before shipping to the customer.

By pre-providing the sensor ports 26,28,30 etc., the manufacturer has an ability to provide a particularly compact valve 10,100 construction possibly with pre-installed sensors 32,34,36 etc. If a sensor is not utilized in this type valve, then the sensor ports 26,28,30 could be capped to prevent leakage therethrough. Alternatively, it may be that some of the port bodies 20,22,24 are replaced with or have traditional port bodies so as not to provide a sensor port thereon for at least some of the ports 12,14,16 etc.

Numerous alterations of the structure herein disclosed will present themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

What is claimed is:

1. A valve comprising:
a valve body connected to and in communication with first, second and third port members;
said first port member having a first port;
said second port member having a first port;
said third port member having a second port;
said valve body having an internal director selectively directing flow through the valve to selectively secure flow through at least one of the first, second and third port members;
wherein a first one of the first, second and third port members have a first sensor port body extending from and integrally formed to the first one of the first, second and third port members with the first sensor port body located intermediate the valve body and its port;
a first sensor secured to the first sensor port body, said first sensor directing having an electronic output related to a characteristic of fluid directed through the first one of the first, second and third port members; and
wherein the first port of the first port member is an inlet, the first port of the second port member is an outlet, and the second port of the third port member is one of an inlet and an outlet.

2. The valve of claim 1 wherein the first sensor port body extends perpendicularly to a direction of flow through the one of the first one of the first, second and third port members.

3. The valve of claim 1 wherein the first sensor is at least one of a pressure and a temperature sensor.

4. The valve of claim 1 wherein the electric output is provided through one of a 2, 3 and a 4 pin connection.

5. The valve of claim 1 wherein a second one of the first, second and third port members has a second sensor port body extending from and integrally formed to the first one of the first, second and third port members with the first sensor port body located intermediate the valve body and its port.

6. The valve of claim 5 further comprising a second sensor secured to the second sensor port body, said second sensor directing having an electronic output related to a characteristic of fluid directed through the second one of the first, second and third port members.

7. The valve of claim 6 wherein the second sensor is at least one of a pressure and a temperature sensor.

8. The valve of claim 7 wherein the first sensor has at least the pressure sensor and the second sensor has at least the temperature sensor and the first and second sensors provide different electronic outputs.

9. The valve of claim 6 wherein the electric output of the second sensor is provided through one of a 2, 3 and a 4 pin connection.

10. The valve of claim 5 wherein the second sensor port body extends perpendicularly to a direction of flow through the second one of the first, second and third port members.

11. The valve of claim 5 wherein a third one of the first, second and third port members has a third sensor port body extending from and integrally formed to the first one of the first, second and third port members with the first sensor port body located intermediate the valve body and its port.

12. The valve of claim 11 further comprising a third sensor secured to the third sensor port body, said third sensor directing having an electronic output related to a characteristic of fluid directed through the third one of the first, second and third port members.

12. The valve of claim 11 wherein the third sensor port body extends perpendicularly to a direction of flow through the third one of the first, second and third port members.

13. The valve of claim 12 wherein the third sensor is at least one of a pressure and a temperature sensor.

14. The valve of claim 13 wherein the electric output of the third sensor is provided through one of a 2, 3 and a 4 pin connection.

15. The valve of claim 5 wherein the second sensor port body is capped.

16. The valve of claim 11 wherein the third sensor port body is capped.

17. The valve of claim 6 wherein the first and second sensor port bodies are threaded and threadedly receive the respective first and second sensors.

18. The valve of claim 17 further comprising nuts securing the first and second sensors to the first and second sensor port bodies.

19. The valve of claim 1 further comprising an electrically driven actuator connected to the valve body which selectively changes a first flow pattern relative to at least one of the first ports and the second port to a second flow pattern.

20. The valve of claim 19 wherein the actuator has an electrical input.
